(19) United States
(12) Patent Application Publication
(10) Pub. No.: US 2023/0399047 A1
(43) Pub. Date: Dec. 14, 2023

(54) STEERING SYSTEM FOR VEHICLE

(71) Applicant: HL MANDO CORPORATION, Gyeonggi-do (KR)

(72) Inventors: Taehyun SUNG, Seoul (KR); Jaehoon BAE, Gyeonggi-do (KR); Dongsik KIM, Gyeonggi-do (KR)

(21) Appl. No.: 18/207,676

(22) Filed: Jun. 9, 2023

(30) Foreign Application Priority Data
Feb. 6, 2020 (KR) 10-2020-0014492
Jun. 10, 2022 (KR) 10-2022-0070852

(51) Int. Cl. B62D 5/04

(52) U.S. Cl. CPC B62D 5/0454; B62D 5/046

(57) ABSTRACT

A steering system for a vehicle includes a rack bar of which both end portions are connected to vehicle wheels and which extends in a width direction of a vehicle body, a motor configured to provide a force, and a gear assembly provided between the rack bar and the motor to transmit the force provided by the motor to the rack bar, wherein the gear assembly includes an input shaft configured to receive the force from the motor, an output shaft configured to transmit the force received through the input shaft to the rack bar, and a seal member provided on an outer circumferential surface of at least one of the input shaft and the output shaft.

### CROSS-REFERENCE TO RELATED APPLICATION

This application claims the benefit of Korean Patent Application No. 10-2022-0070852, filed on Jun. 10, 2022 in the Korean Intellectual Property Office, the disclosure of which is incorporated herein by reference.

### BACKGROUND

### 1. Technical Field

Embodiments of the present disclosure generally relate to a steering system for a vehicle, and more particularly, to a steering system for a vehicle for preventing deformation of various components of the steering system such as gears to increase durability and simultaneously improve operational reliability.

### 2. Description of the Related Art

In general, power-assisted steering devices are applied to vehicles to assist with a steering force of a driver who manipulates a steering wheel. Examples of power-assisted steering devices include hydraulic power steering (HPS) devices that assist with a steering force using hydraulic pressure generated by a pump, and motor driven power steering (MDPS) devices that assist with a steering force using rotation power of a motor, and the like.

Among the power-assisted steering devices, in the MDPS device, based on driving conditions of the vehicle detected by a torque sensor and a vehicle speed sensor of a steering wheel, an electronic control unit drives a motor to assist with a steering force for steering the vehicle. Such MDPS provides a light and comfortable steering feeling when the vehicle travels at a low speed and provides a stable steering feeling and excellent vehicle steerability when the vehicle travels at a high speed. In addition, MDPS assists in quickly restoring a rotated steering wheel, thereby providing a convenient steering condition to the driver in any operating condition of the vehicle.

Typically, the MDPS device includes a motor for providing power and a gear assembly for transmitting a rotational force generated by the motor to a column connected to a steering wheel or a rack bar connected to a wheel and may be classified into various types according to installation positions of the motor and the gear assembly. As an example, the MDPS devices may be classified into column-assist type electronic power steering (C-EPS) devices in which a motor is mounted on a column side, pinion-assist type electronic power steering (P-EPS) devices in which a motor is mounted on a pinion gear side, and rack-assist type electronic power steering (R-EPS) devices in which a motor is mounted on a rack bar side. Furthermore, recently, steer-by-wire (SbW) type steering systems are being developed in which a steering intention of a driver is transmitted as an electrical signal without a mechanical connection between a steering wheel and wheels, and based on the electrical signal, a motor is operated to steer the wheels.

Meanwhile, in a gear assembly applied to electric power steering, a plurality of gear elements rotate and operate while engaged with each other, and when a vehicle operates in a damp environment such as rain or heavy snowfall, there is a risk that moisture may enter the gear elements and cause deformation thereof. When a clearance occurs between gears due to the deformation of the gear elements, operating noise and vibration of a device may occur, which may degrade quality and performance of driving the vehicle and may adversely affect the steering stability of a vehicle, causing a risk of a safety-related accident. On the other hand, when a separate clearance compensator is applied to prevent the clearance caused by the deformation of the gear elements, there may be a problem that the manufacturing costs increase and production efficiency decreases due to the addition of parts for the separate clearance compensator.

Therefore, there is a need for an apparatus and method capable of improving the durability of various components applied to a steering system for a vehicle, improving the performance and operational reliability of the steering system, suppressing an increase in manufacturing cost, and improving assemblability and productivity.

### RELATED ART DOCUMENTS

### Patent Documents

Korean Patent Publication No. 10-2005-0040203 (published on May 3, 2005)

### SUMMARY

It is an aspect of the present disclosure to provide a steering system for a vehicle preventing deformation of various components of the steering system and improving durability.

It is another aspect of the present disclosure to provide a steering system for a vehicle in which a clearance between gear elements is prevented to improve operational reliability.

It is a still another aspect of the present disclosure to provide a steering system for a vehicle reducing operating noise and vibrations.

It is yet another aspect of the present disclosure to provide a steering system for a vehicle in which the efficiency of manufacturing and installation processes of the steering system is improved with a simple structure.

It is a yet another aspect of the present disclosure to provide a steering system for a vehicle in which an increase in manufacturing cost of the steering system is suppressed to improve product competitiveness.

It is a yet another aspect of the present disclosure to provide a steering system for a vehicle capable of stably steering vehicle wheels under various operating conditions of the vehicle and giving a comfortable operational feeling to a driver.

Additional aspects of the disclosure will be set forth in part in the description which follows and, in part, will be obvious from the description, or may be learned by practice of the disclosure.

In accordance with one aspect of the present disclosure, a steering system for a vehicle includes a rack bar of which both end portions are connected to wheels and which extends in a width direction of a vehicle body, a motor configured to receive power from a power supply and provide the power, and a gear assembly provided between the rack bar and the motor to transmit the power provided by the motor to the rack bar, wherein the gear assembly includes an input shaft to which the power is transmitted from the motor, an output shaft configured to transmit the power to the rack bar, and a sealing member provided on an outer circumferential surface of at least one of the input shaft and the output shaft.

The gear assembly may further include a reduction gear provided between the input shaft and the output shaft, and the sealing member may include an oil seal having a ring shape to prevent external moisture from entering the reduction gear and prevent leakage of a lubricant applied to the gear assembly.

The gear assembly may further include a gear housing in which the input shaft, the reduction gear, and the output shaft are accommodated and installed, and the oil seal may include a first oil seal provided between the input shaft and the gear housing and a second oil seal provided between the output shaft and the gear housing.

The gear housing may include an input opening formed to pass therethrough such that at least a portion of the input shaft passes through the input opening and is exposed toward the motor, and an output opening formed to pass therethrough such that at least a portion of the output shaft passes through the output opening and is exposed toward the rack bar, the first oil seal may be interposed between the input shaft and an inner circumferential surface of the input opening, and the second oil seal may be interposed between the output shaft and an inner circumferential surface of the output opening.

The input shaft may include a first screw portion on an outer circumferential surface of which first gear teeth engaged with the reduction gear are formed, and a first body provided integrally with the first screw portion and formed to extend toward the motor, and the first oil seal is interposed between an outer circumferential surface of the first body and an inner circumferential surface of the input opening.

The output shaft may include a second screw portion on an outer circumferential surface of which second gear teeth engaged with the rack bar are formed, and a second body provided integrally with the second screw portion and formed to extend toward the reduction gear, and the second oil seal may be interposed between an outer circumferential surface of the second body and the inner circumferential surface of the output opening.

The gear assembly may further include a first bearing provided between the first body and the inner circumferential surface of the input opening, and a damping member provided between the first oil seal and the first bearing.

The first oil seal may include an accommodation groove formed to be recessed on an inner circumferential surface thereof such that at least a portion of the damping member is inserted therein.

The gear assembly may further include a second bearing provided between the second body and the inner circumferential surface of the output opening.

The second oil seal may include an anti-contact groove recessed on an inner surface thereof or formed by cutting the inner surface to prevent contact with an inner ring of the second bearing.

The gear assembly may further include a first sealing plug mounted in the input opening or on the first body to support the first oil seal.

The gear assembly may further include a second sealing plug mounted in the output opening to support the second oil seal.

The steering system may further include a motor housing configured to accommodate the motor, and a first O-ring provided between the gear housing and the motor housing.

The input shaft may be provided as a worm shaft, and the reduction gear may be provided as a worm wheel which is engaged with the worm shaft and rotated together with the output shaft.

The output shaft may be provided as a pinion shaft which is rotated coaxially with the worm wheel and is engaged with the rack bar.

The worm wheel may include worm gear teeth provided on an outer circumferential surface thereof, and the worm gear teeth may be made of a polyamide material.

The gear housing may further include a moisture absorbent provided on an inner surface to adsorb moisture entering the inside.

The steering system may further include a rack bar housing which is hollow to have an accommodation space for accommodating the rack bar therein and includes a stretchable bellows mounted at each of two end portions thereof.

The rack bar housing may include at least one vent hole formed to pass therethrough and allow an air flow between the outside and the accommodation space.

The rack bar housing may further include a cap member mounted in the vent hole to allow an air flow and suppress inflow of foreign materials.

The rack bar housing may further include a filter member mounted in the vent hole to allow an air flow and prevent foreign materials and moisture from passing therethrough.

The steering system may further include a second O-ring provided between the gear housing and the rack bar housing.

The steering system may further include an electronic control unit configured to control an operation of the motor, and the motor and the electronic control unit may be provided as a power pack.

The steering system may further include an angle sensor configured to detect rotation of the output shaft and transmit detected information to the electronic control unit, and a sensor connector configured to electrically connect the angle sensor to the electronic control unit.

The gear housing may further include a detection opening formed to pass through a side opposite to the output opening, and a sensor cover provided to cover the detection sensor, and the angle sensor and the sensor connector may be supported and mounted on the sensor cover.

The angle sensor may be supported on an inner surface of the sensor cover, the sensor connector may be provided on an outer surface through a connector hole formed to pass through the sensor cover, and the sensor connector may include a grommet configured to seal the connector hole.

The steering system may further include a third O-ring provided between the gear housing and the sensor cover.

In accordance with another aspect of the present disclosure, a steering system for a vehicle includes a rack bar of which both end portions are connected to wheels and which extends in a width direction of a vehicle body, a rack bar housing which is hollow to have an accommodation space for accommodating the rack bar therein and includes a stretchable bellows mounted at each of two end portions thereof, a motor configured to receive power from a power supply and provide the power, and a gear assembly provided between the rack bar and the motor to transmit the power provided by the motor to the rack bar, wherein the gear assembly includes at least one oil seal configured to seal the inside from the outside, and the rack bar housing includes at least one vent hole formed to pass therethrough to allow an air flow between the outside and the accommodation space.

In accordance with still another aspect of the present disclosure, a steering system for a vehicle includes a rack bar of which both end portions are connected to wheels and which extends in a width direction of a vehicle body, a rack bar housing which is hollow to have an accommodation space for accommodating the rack bar therein, a bellows which is provided at each of two end portions of the rack bar housing to surround both sides of the rack bar and of which an inner space communicates with the accommodation space, a motor configured to receive power from a power supply and provide the power, and a gear assembly which is provided between the rack bar and the motor to transmit the power provided by the motor to the rack bar and of which the inside is sealed from the accommodation space, wherein the rack bar housing includes at least one vent hole formed to pass therethrough to allow an air flow between the outside and the accommodation space.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view for illustrating a steering system for a vehicle according to an embodiment of the present disclosure;

FIG. 2 is a lateral cross-sectional view for illustrating main parts of a steering system for a vehicle according to an embodiment of the present disclosure;

FIG. 3 is a cut-away perspective view for illustrating main parts of a steering system of a vehicle according to an embodiment of the present disclosure;

FIG. 4 is an enlarged lateral cross-sectional view for showing an input shaft side of a gear assembly according to an embodiment of the present disclosure;

FIG. 5 is an enlarged lateral cross-sectional view for illustrating an output shaft side of a gear assembly according to an embodiment of the present disclosure;

FIG. 6 is a perspective view for illustrating a gear housing according to an embodiment of the present disclosure;

FIG. 7 is another perspective view for illustrating a gear housing according to an embodiment of the present disclosure;

FIG. 8 is a perspective view for illustrating a gear housing in which an input shaft and a first oil seal are mounted in an input opening of the gear housing according to an embodiment of the present disclosure;

FIG. 9 is another perspective view for illustrating a gear housing in which an input shaft and a second oil seal are mounted in an output opening of the gear housing according to an embodiment of the present disclosure;

FIG. 10 is an exploded perspective view for showing a gear housing, a first and a power pack according to an embodiment of the present disclosure;

FIG. 11 is an exploded perspective view for illustrating a gear housing, a second O-ring, and a rack bar housing according to an embodiment of the present disclosure;

FIG. 12 is an exploded perspective view for showing a gear housing, a third and a sensor cover according to an embodiment of the present disclosure;

FIG. 13 is a cross-sectional view cut along line A-A′ of FIG. 2; and

FIG. 14 is a cross-sectional view for illustrating main parts of a steering system for a vehicle according to a modified embodiment of the present disclosure.

### DETAILED DESCRIPTION

Hereinafter, embodiments of the present disclosure will be described in detail with reference to the accompanying drawings. Embodiments described below are exemplarily provided to sufficiently inform those skilled in the art of the spirit of the present disclosure. Rather than being limited to the embodiments described below, the present disclosure may be implemented in other forms. In the drawings, parts that are irrelevant to the descriptions may not be shown in order to clarify the present disclosure, and also, for easy understanding, the sizes of components may be exaggerated to varying extents.

A steering system 100 for a vehicle according to some embodiments of the present disclosure may be provided as a steer-by-wire type steering system which receives a steering intention of a driver as an electrical signal without mechanical connections between a steering wheel and vehicle wheels and operates a motor to be described below based on the electrical signal to steer the vehicle wheels. However, this is merely an example for helping understanding of the present disclosure, and the present disclosure is not limited thereto. As long as a motor may be driven to assist with a steering force for steering a vehicle, it can be understood that the steering system 100 can be provided as any one of various types of steering systems such as a column-assist type electronic power steering (C-EPS) system and a rack-assist type electronic power steering (R-EPS) system.

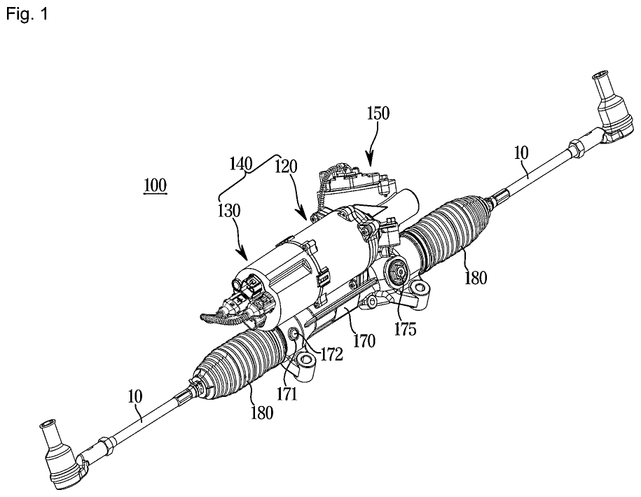

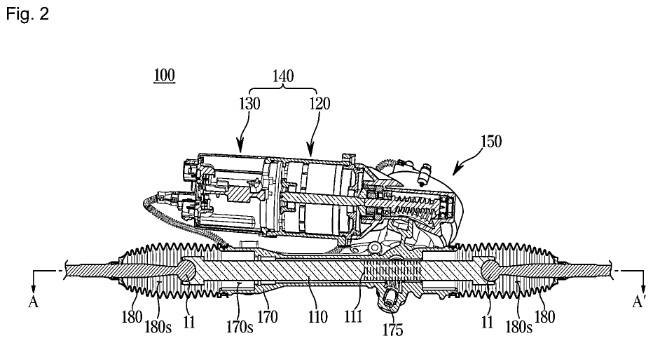

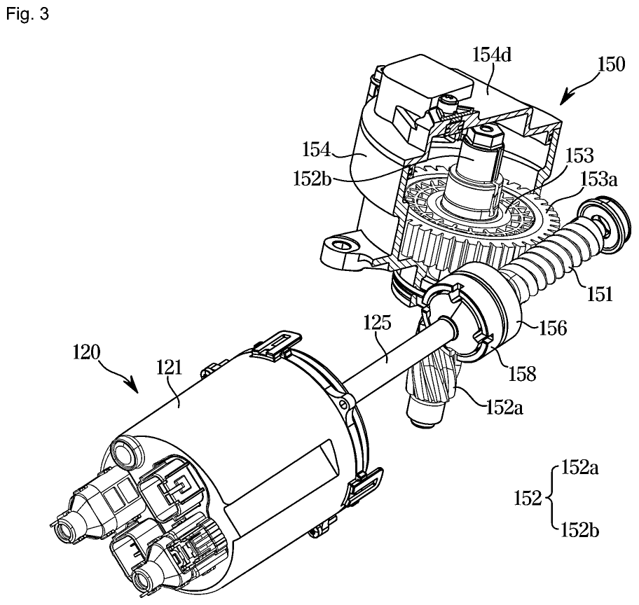

FIG. 1 is a perspective view illustrating the steering system 100 for a vehicle according an embodiment of to the present disclosure. FIGS. 2 and 3 are a lateral cross-sectional view and a cut-away perspective view illustrating main parts of the steering system 100 for the vehicle according to an embodiment of the present disclosure, respectively.

Referring to FIGS. 1 to 3, the steering system 100 for the vehicle according to an embodiment of the present disclosure may include a rack bar 110 of which both end portions are connected to vehicle wheels, a rack bar housing 170 in which the rack bar 110 is accommodated and installed, a motor 120 configured to receive power from a power supply and provide power or force, a gear assembly 150 configured to transmit the force provided from the motor 120 to the rack bar 110, and an electronic control unit (ECU) 130 configured to control the operation of the motor 120.

The rack bar 110 may be formed to extend in a bar shape in a width direction of the vehicle, and both end portions of the rack bar 110 may be connected to a pair of vehicle wheels through ball joints 11 and tie rods 10. The rack bar 110 may be provided with rack gear teeth 111 to perform a translational motion in the width direction (left-right direction in FIG. 2) of the vehicle by rotation force transmitted from the gear assembly 150 to be described below, and the rack gear teeth 111 may be engaged with pinion gear teeth 152a of an output shaft or pinion shaft 152 to be described below. A pair of vehicle wheels connected to both end portions of the rack bar 110, respectively, may be steered by the translational motion of the rack bar 110.

The rack bar 110 may be accommodated and installed inside the rack bar housing 170. For example, the rack bar housing 170 may be formed to be hollow such that an accommodation space 170s for accommodating the rack bar 110 can be formed in the rack bar housing 170, and a stretchable bellows 180 may be provided at each of two end portions of the rack bar housing 170. The stretchable bellows 180 may be provided to surround at least portions of both end portions of the rack bar 110 and the ball joints 11 and may have a plurality of wrinkles such that a shape of the stretchable bellows 180 is easily deformable according to the translational motion of the rack bar 110. A pair of bellows 180 may be coupled to both end portions of the rack bar housing 170 through steel bands, respectively, and inner spaces 180s of the bellows 180 may communicate with the accommodation space 170s of the rack bar housing 170. The stretchable bellows 180 are provided to surround at least portions of both end portions of the rack bar 110 and the ball joints 11, thereby preventing external foreign materials or moisture from entering the ball joints 11.

The rack bar housing 170 may include a yoke plug 175 that presses the rack bar 110 toward the pinion shaft 152 to be described below to stably maintain engagement between the rack gear teeth 111 and pinion gear teeth 152a of the pinion shaft 152 to be described below. The yoke plug 175 may be disposed to pass through an opening formed to pass through the rack bar housing 170, and thus an inner end of the yoke plug 175 may come into close contact with and press a part of the rack bar 110. A seal member is interposed between an outer circumferential surface of the yoke plug 175 and an inner circumferential surface of the opening to prevent external moisture or foreign materials from flowing into the accommodation space 170s.

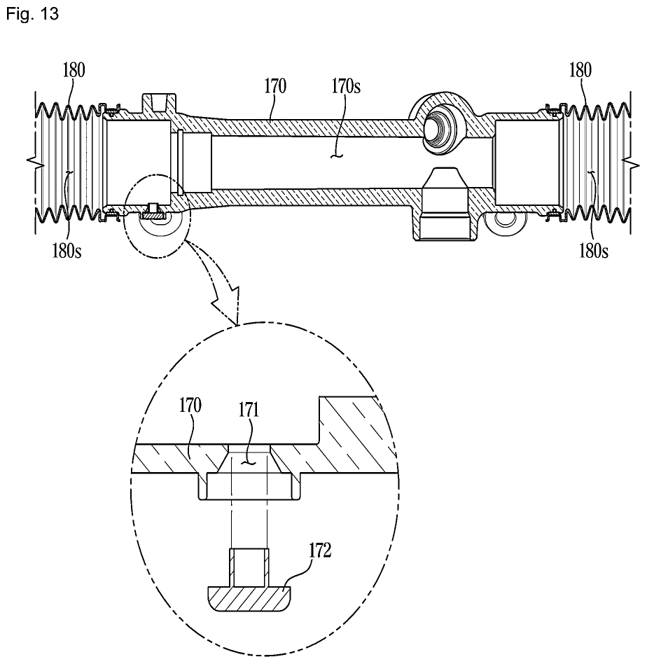

Meanwhile, when the bellows 180 is stretched or contracted by being deformed by the translational motion of the rack bar 110, while air present in the accommodation space 170s of the rack bar housing 170 and the inner space 180s of the bellows 180 flows, a load may be applied to at least a portion of the bellows 180 by pressure or negative pressure. When the steering system 100 is repeatedly operated according to vehicle operation, there may be a risk that the bellows 180 may be damaged or deformed by the load applied to the bellows 180. Accordingly, a vent hole 171 may be formed in or at the rack bar housing 170 to allow the accommodation space 170s and the inner space 180s of the bellows 180 to communicate with the outside of the rack bar housing 170, thereby reducing or minimizing the load applied to the bellows 180 due to an air flow. This will be described below with reference to FIG. 13.

The motor 120 is configured to receive power from a power supply such as a battery of the vehicle and generate and provide force or power for steering the vehicle. The operation of the motor 120 may be controlled by receiving an operation signal from the ECU 130, and the motor 120 and the ECU 130 may be provided as a power pack 140. To this end, a motor housing 121 accommodating the motor 120 and the ECU 130 may be assembled with each other through fastening or coupling members such as bolts and clips. Specifically, a rear portion (e.g. a left portion in FIG. 2) of the motor housing 121 and a front portion (e.g. a right portion in FIG. 2) of the ECU 130 are fastened or coupled to each other to form the power pack 140, and a plurality of connectors electrically connected to the battery of the vehicle and an angle sensor 131 to be described below may be provided at a rear portion (e.g. a left portion in FIG. 2) of the ECU 130.

The ECU 130 may be, for example, but not limited to, a processor or controller, or any suitable circuitry and/or electronic components, such as a microprocessor.

The motor 120 may receive power to generate rotation force or power. The motor 120 may be provided as a bi-directional motor 120 to easily implement a translational motion of the rack bar 110 in the width direction of the vehicle (e.g. a left-right direction in FIG. 2). Thus, when the motor 120 rotates in one direction, the rack bar 110 may perform a translational motion in one direction, and in contrast, when the motor 120 rotates in the other direction, the rack bar 110 may perform a translational motion in the other direction so that the vehicle wheels may be steered accordingly. A commonly known motor including a rotor, a stator, and the like may be applied or used as the motor 120, and the motor housing 121 may be provided to accommodate such components of the motor therein.

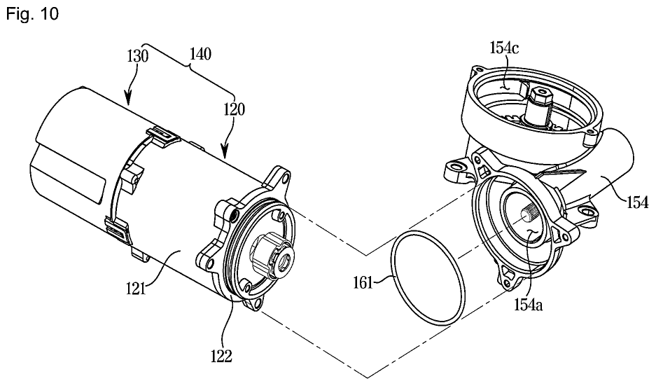

A driving shaft 125 of the motor 120 may pass through a motor cover 122 provided at a front portion (right portion in FIG. 2) of the motor housing 121 and may be exposed toward and coupled to the gear assembly 150 to be described below. The driving shaft 125 may be coupled to an input shaft 151 of the gear assembly 150 to be described below by a damping coupler 126, and as a result, the driving shaft 125 of the motor 120 and the input shaft 151 of the gear assembly 150 may operate integrally and may be fixed to each other. The motor housing 121 and the gear housing 154 of the gear assembly 150 to be described below may be assembled and coupled to each other through coupling or fastening means or members such as bolts. In addition, an O-ring for preventing inflow of moisture or foreign materials into the motor housing 121 and the gear housing 154 may be provided between the motor housing 121 and the gear housing 154 to be described below, and a detailed description thereof will be provided below with reference to FIG. 10.

The gear assembly 150 is provided between the motor 120 and the rack bar 110 to reduce the force power provided from the motor 120 and transmit the reduced force or power to the rack bar 110.

The gear assembly 150 may include the gear housing 154 in which components are accommodated and installed, the input shaft 151 of the gear assembly 150 configured to receive the force or power from the motor 120, a reduction gear 153 configured to reduce the force or power transmitted to the input shaft 151, an output shaft 152 configured to transmit the force or power reduced by the reduction gear 153 to the rack bar 110, and seal members 156 and 157 provided on the input shaft 151 and the output shaft 152 to prevent leakage of a lubricant and prevent external moisture or objects from entering the gear assembly 150 or the reduction gear 153.

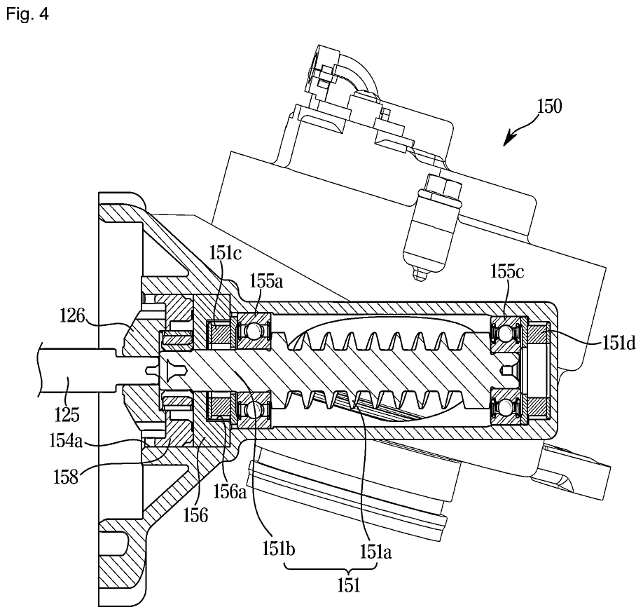

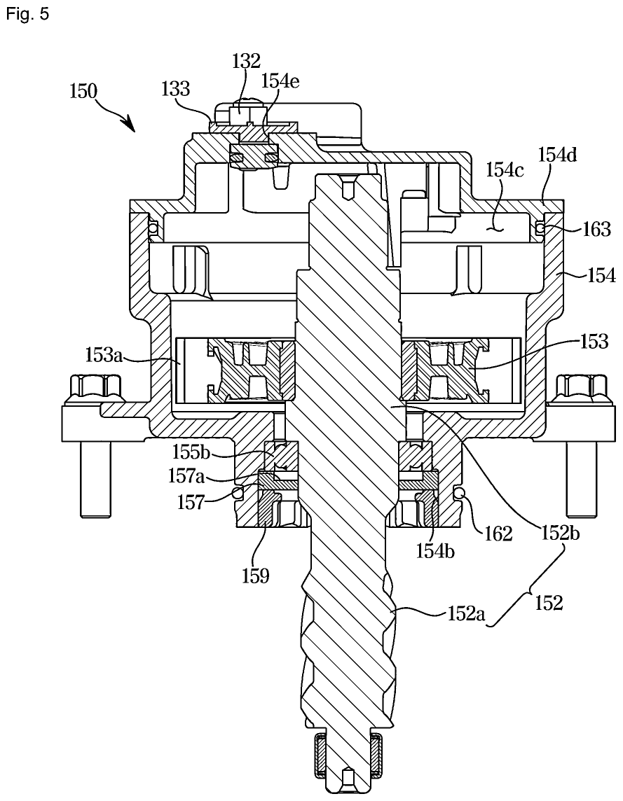

FIG. 4 is an enlarged lateral cross-sectional view of the gear assembly 150 including the input shaft 151 according to an embodiment of the present disclosure. FIG. 5 is another enlarged lateral cross-sectional view of the gear assembly 150 with the output shaft 152 according to an embodiment of the present disclosure.

Referring to FIGS. 2 to 4, the input shaft 151 of the gear assembly 150 is provided to receive rotation force or power from the motor 120. The input shaft 151 may include a first screw portion 151a having first gear teeth engaged with the reduction gear 153 and formed on an outer circumferential surface of the input shaft 151, and a first body 151b formed to extend from the first screw portion 151a toward the motor 120. An end portion of the first body 151b may pass through an input opening 154a of the gear housing 154 to be described below and may be coupled to the driving shaft 125 of the motor 120 by the damping coupler 126, and thus the driving shaft 125 and the input shaft 151 may rotate together integrally. The first gear teeth of the first screw portion 151a may be engaged with the reduction gear 153 to be described below to transmit the force or power to the reduction gear 153. As an example, the input shaft 151 of the gear assembly 150 may be provided as a worm shaft, and the first screw portion 151a of the input shaft 151 may be formed as a worm screw thread. A first oil seal 156 of a seal member described below may be provided between an outer circumferential surface of the first body 151b and an inner circumferential surface of the input opening 154a. The separation of the first oil seal 156 from the gear housing 154 may be prevented by a first sealing plug 158, which will be described in detail below.

First bearings 155a and 155c may be provided at or adjacent to both sides or ends of the first screw portion 151a of the input shaft 151 of the gear assembly 150. The first bearings 155a and 155c may be interposed between the gear housing 154 and the input shaft 151 to enable support to or smooth rotation of the input shaft 151 and reduce noise and wear during operation thereof. In addition, damping members or dampers 151c and 151d may be provided at both sides or ends of the first screw portion 151a. The first damping member or damper 151c provided adjacent to the first body 151b is provided to suppress deformation of the first oil seal 156 caused by contact between the first bearing 155a and the first oil seal 156 to be described below, and the second damping member or damper 151d provided at an inner end portion (e.g. a right end portion in FIG. 4) of the input shaft 151 may prevent or reduce shock and noise caused by contact between the input shaft 151 and the gear housing 154. The first damping member 151c may be disposed to be seated inside an accommodation groove 156a formed to be recessed on an inner circumferential surface of the first oil seal 156.

The reduction gear 153 is provided to reduce the force or power transmitted from the input shaft 151 and transmit the reduced force or power to the output shaft 152. Referring to FIGS. 2, 3, and 5, the reduction gear 153 may be accommodated inside the gear housing 154 like the input shaft 151 and may be engaged with the first gear teeth of the input shaft 151 to receive rotation force or power. The reduction gear 153 and the output shaft 152 may be engaged coupled to each other to be coaxially rotatable together. Worm gear teeth 153a engaged with the first gear teeth of the input shaft 151 may be provided on an outer circumferential surface of the reduction gear 153. As an example, the input shaft 151 may be provided as a worm shaft, and the reduction gear 153 may be provided as a worm wheel engaged with the worm shaft 151. The worm gear teeth 153a of the reduction gear 153 engaged with a worm thread 151a of the worm shaft 151 may be provided on an outer circumferential surface of the worm wheel 153 and may be made of a polyamide material to reduce a weight of a product and reduce operating noise, although not required.

The output shaft 152 of the gear assembly 150 is rotatably coupled to the reduction gear 153 to be rotatable together integrally with the reduction gear 153, thereby transmitting rotation force or power reduced by the reduction gear 153 to the rack bar 110. The output shaft 152 may rotate coaxially with the worm wheel 153 (i.e. the reduction gear 153), and may include a second screw portion 152a in which second gear teeth of the second screw portion 152a engaged with the rack gear teeth 111 are formed on an outer circumferential surface of the second screw portion 152a, and a second body 152b which extends from the second screw portion 152a of the output shaft 152 toward the reduction gear 153. An end portion of the second body 152b may be coupled to the worm wheel 153 by passing through an output opening 154b of the gear housing 154 to be described below. The second gear teeth of the second screw portion 152a may be provided as pinion gear teeth engaged with the rack gear teeth 111 of the rack bar 110. In other words, the output shaft 152 may be provided as a pinion shaft that rotates coaxially with the worm wheel 153. The pinion gear teeth 152a may be engaged with the rack gear teeth 111 of the rack bar 110, and thus a rotation motion of the pinion shaft 152 may be converted into a translational motion of the rack bar 110. The second oil seal 157 of the seal member described below is provided between an outer circumferential surface of the second body 152b of the output shaft 152 and an inner circumferential surface of the output opening 154b of the gear housing 154. The separation of the second oil seal 157 from the gear housing 154 may be prevented by a second sealing plug 159, which will be described in detail below.

A second bearing 155b may be provided on the second body 152b. The second bearing 155b may be interposed between the output opening 154b of the gear housing 154 and the output shaft 152 of the gear assembly 150 to enable support to or smooth rotation of the output shaft 152 and reduce noise and wear during operation thereof. In addition, the angle sensor 131 configured to detect a rotation angle of the output shaft 152 and transmit detected angle information to the ECU 130 may be provided at an inner end portion (e.g. an upper end portion in FIG. of the second body 152b.

The gear housing 154 is provided for various components such as the input shaft 151, the reduction gear 153, and the output shaft 152 to accommodate and install them in the gear housing 154.

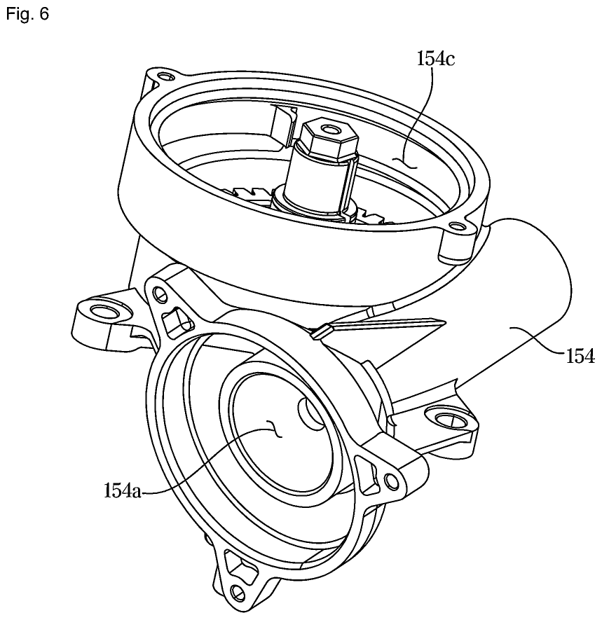

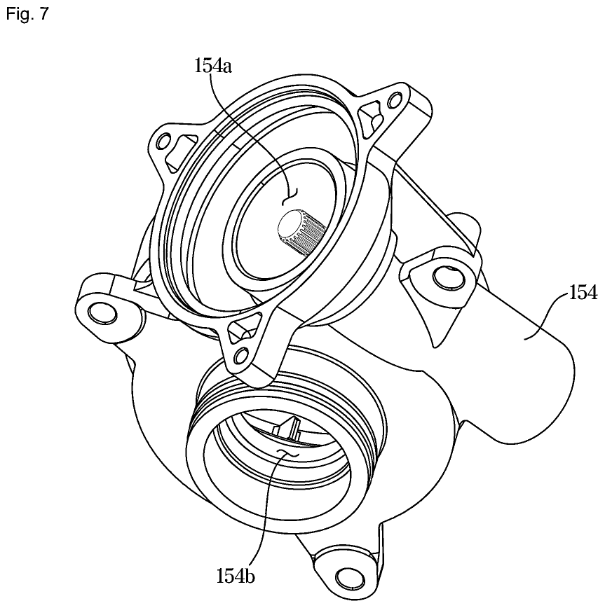

FIGS. 6 and 7 are perspective views illustrating the gear housing 154 in different directions according to an embodiment of the present disclosure. Referring to FIGS. 2 to 7, the gear housing 154 may include the input opening 154a formed to pass therethrough such that at least a portion of the input shaft 151 of the gear assembly 150 can be exposed to the motor 120, the output opening 154b formed to pass therethrough such that at least a portion of the output shaft 152 of the gear assembly 150 can be exposed to the rack bar 110, and a detection opening 154c formed to pass through a side opposite to the output opening 154b.

The input opening 154a may be formed to pass through a side portion of the gear housing 154 facing the motor housing 121 such that at least a portion of the first body 151b of the input shaft 151 may be connected to the driving shaft 125 of the motor 120. The first bearing 155a may be mounted in the input opening 154a, and an outer circumferential surface of the first oil seal 156 to be described below may be in close contact with the inner circumferential surface of the input opening 154a, thereby sealing the input opening 154a. In addition, the first sealing plug 158 supporting the first oil seal 156 and preventing the separation of the first oil seal 156 from the input opening 154a may be inserted and mounted in the input opening 154a at the outside of the first oil seal 156.

The output opening 154b may be formed to pass through a side portion of the gear housing 154 facing the rack bar housing 170 such that at least a portion of the second screw portion 152a of the output shaft 152 may be engaged with the rack gear teeth 111 of the rack bar 110. The second bearing 155b may be mounted in the output opening 154b, and an outer circumferential surface of the second oil seal 157 to be described below may be in close contact with the inner circumferential surface of the output opening 154b, thereby sealing the output opening 154b. In addition, the second sealing plug 159 supporting the second oil seal 157 and preventing the separation of the second oil seal 157 from the output opening 154b may be inserted and mounted in the output opening 154b at the outside of the second oil seal 157.

The detection opening 154c may be formed to pass through a side portion of the gear housing 154 opposite to the output opening 154b to facilitate installation of the angle sensor 131 and a sensor connector 132. Referring to FIGS. 5 and 6, the detection opening 154c may be sealed by a sensor cover 154d, and an O-ring 163 to be described below may be interposed between the detection opening 154c and the sensor cover 154d to seal a space therebetween. The angle sensor 131 may detect a rotation angle of the output shaft 152 of the gear assembly 150, and the sensor connector 132 may electrically connect the angle sensor 131 and the ECU 130 to transmit information detected by the angle sensor 131, or a signal related to detection of the angle sensor 131, to the ECU 130. To this end, the angle sensor 131 may be supported and mounted on an inner surface of the sensor cover 154d, and the sensor connector 132 may pass through a connector hole 154e formed to pass through the sensor cover 154d and may be provided to be exposed at an outer surface thereof. The sensor connector 132 may include a grommet 133 made of an elastically deformable material. The grommet 133 may seal the connector hole 154e, thereby preventing a lubricant inside the gear housing 154 from leaking to the outside of the gear housing 154 through the connector hole 154e and preventing external moisture or objects from entering the gear housing 154 through the connector hole 154e.

Meanwhile, as described above, the worm gear teeth 153a of the worm wheel 153 may be made of, for example, but not limited to, a polyamide material to reduce operating noise. However, the worm gear teeth 153a to which polyamide is applied may be lighter and have higher rigidity as compared with a metal but may have a high water absorption rate and therefore have a risk of deformation due to moisture absorption. When the worm wheel 153 is deformed, operating noise and vibration occur, and product performance and operational reliability are adversely affected, and thus it is necessary to prevent moisture from flowing into or entering an inner space of the gear housing 154 in which the worm wheel 153 is installed.

Accordingly, in the steering system 100 for the vehicle according to certain embodiments of the present disclosure, the seal member may be provided to seal or separate the inner space of the gear housing 154 from an inner space of the motor housing 121, which is a space adjacent to the inner space of the gear housing 154, and the accommodation space of the rack bar housing 170. The seal member may include the first oil seal 156 and the second oil seal 157 which are provided on the outer circumferential surfaces of the input shaft 151 and the output shaft 152, respectively, to prevent moisture or objects from entering the gear housing 154 or the reduction gear 153 from the outside of the gear housing 154 and prevent leakage of a lubricant oil applied to the gear assembly 150.

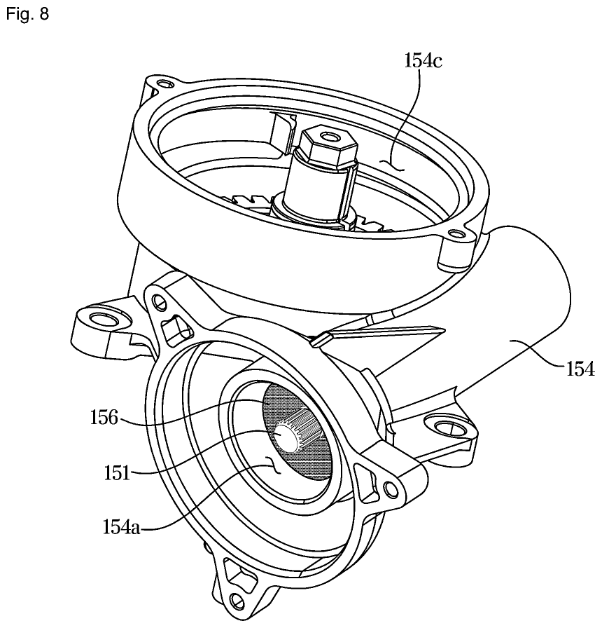

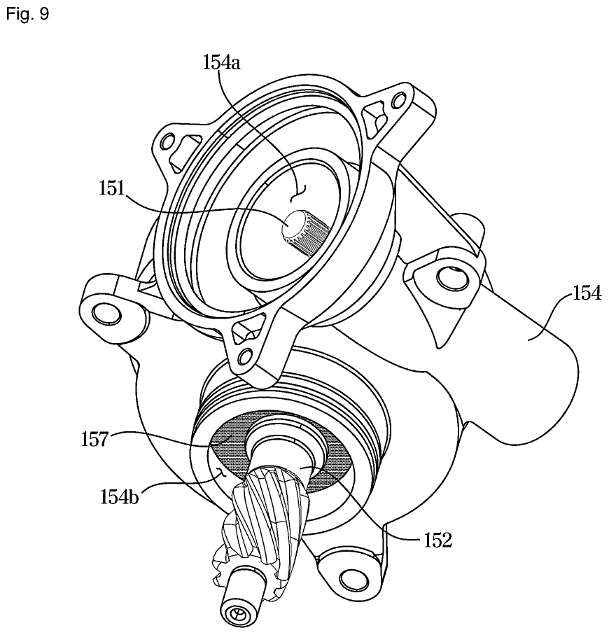

FIG. 8 is a perspective view illustrating the gear housing 150 in which the input shaft 151 and the first oil seal 156 are mounted in the input opening 154a of the gear housing 154 according to an embodiment of the present disclosure. FIG. 9 is another perspective view illustrating the gear housing 150 in which the output shaft 152 and the second oil seal 157 are mounted in the output opening 154b of the gear housing 154 according to an embodiment of the present disclosure.

Referring to FIGS. 2, 4, and 8, the first oil seal 156 may be provided between the input opening 154a of the gear housing 154 and the input shaft 151 of the gear assembly 150 in the gear housing 154. For example, the first oil seal 156 may be provided in a ring shape and may be made of an elastically deformable material, and an inner circumferential surface of the first oil seal 156 may be in close contact with the outer circumferential surface of the first body 151b of the input shaft 151 of the gear assembly 150 and an outer circumferential surface of the first oil seal 156 may be in close contact with the inner circumferential surface of the input opening 154a of the gear housing 154, thereby sealing the input opening 154a. At least a portion of the inner circumferential surface of the first oil seal 156 may have recess to form an accommodation groove 156a, and a damping member 151c may be seated and provided on the accommodation groove 156a of the first oil seal 156. Since the damping member 151c for suppressing shock and vibration is inserted into and disposed on the accommodation groove 156a of the first oil seal 156, lengthening of the input shaft 151 may be suppressed, and the size of the steering system 100 may be reduced or miniaturized. In addition, the first sealing plug 158 may be mounted to the outside of the first oil seal 156 such that the first oil seal 156 can be stably supported on the first body 151b and can be prevented from being separated from the gear housing 154. The first sealing plug 158 may be mounted on the first body 151b of the input shaft 151 or may also be mounted on the inner circumferential surface of the input opening 154a of the gear housing 154 to support the first oil seal 156.

As described above, since the inner and outer circumferential surfaces of the first oil seal 156 are in close contact with an outer circumferential surface of the input shaft 151 and the inner circumferential surface of the input opening 154a, respectively, the inner space of the gear housing 154 can be sealed from the inner space of the motor housing 121 with a simple structure, and thus moisture can be easily prevented or suppressed from entering the worm wheel 153 from the motor 120 or the motor housing 121.

Referring to FIGS. 5 and 9, the second oil seal 157 may be provided between the output opening 154b of the gear housing 154 and the output shaft 152 of the gear assembly 150. For example, like the first oil seal 156, the second oil seal 157 may be provided in a ring shape and may be made of an elastically deformable material, and an inner circumferential surface of the second oil seal 157 may be in close contact with the outer circumferential surface of the second body 152b and an outer circumferential surface of the second oil seal 157 may be in close contact with the inner circumferential surface of the output opening 154b of the gear housing 154, thereby sealing the output opening 154b of the gear housing 154. An anti-contact groove 157a may be recessed or formed by cutting at least a portion of an inner surface (the upper surface in FIG. 4) of the second oil seal 157 facing the second bearing 155b. When the output shaft 152 of the gear assembly 150 rotates while the second oil seal 157 may be in contact with an inner ring or ball of the second bearing 155b, since the inner ring and the ball of the second bearing 155b also rotate together with the output shaft 152, friction may occur between the second oil seal 157 and the inner ring of the second bearing 155b, thereby causing a risk of the second oil seal 157 becoming worn or damaged. Accordingly, the anti-contact groove 157a may be recessed or formed by cutting a portion adjacent to the inner ring and the ball that rotate on an inner surface of the second oil seal 157, and thus a gap or space may be formed between the second bearing 155b and the second oil seal 157 to prevent damage to the second oil seal 157 and improve durability. In addition, the second sealing plug 159 may be mounted at the outside of the second oil seal 157 such that the second oil seal 157 can be stably supported on the second body 152b and can be prevented from being separated from the gear housing 154. The second sealing plug 159 may be mounted on the second body 152b of the output shaft 152 or may be mounted on the inner circumferential surface of the output opening 154b of the gear housing 154 to support the second oil seal 157.

As described above, since inner and outer circumferential surfaces of the second oil seal 157 are in close contact with an outer circumferential surface of the output shaft 152 of the gear assembly 150 and the inner circumferential surface of the output opening 154b of the gear housing 154, respectively, the inner space of the gear housing 154 can be sealed from the inner space 170s of the motor housing 170, thereby preventing moisture from entering the worm wheel 153 from the rack bar 110 or the rack bar housing 170.

Hereinafter, O-rings sealing the inner space of the gear housing 154 from the outside of the steering system 100 will be described.

The O-rings include a first O-ring 161 provided between the gear housing 154 and the motor housing 121, a second O-ring 162 provided between the gear housing 154 and the rack bar housing 170, and a third O-ring 163 provided between the gear housing 154 and the sensor cover 154d.

FIG. 10 is an exploded perspective view of the gear housing 154, the first 161, and the power pack 140 according to an embodiment of the present disclosure. Referring to FIG. 10, the first O-ring 161 is provided between a side of the input opening 154a of the gear housing 154 and the motor cover 122 of the motor housing 121, thereby preventing moisture from entering the inner space of the gear housing 154 from the outside of the gear housing 154. For instance, the first O-ring 161 may be provided in a ring shape, may be made of an elastically deformable material, and may be seated on an O-ring accommodation groove formed to be recessed in a radial direction on the inner circumferential surface of the input opening 154a of the gear housing 154, thereby preemptively preventing external moisture from flowing into the inner space of the gear housing 154. However, although FIG. 10 shows that the O-ring accommodation groove is formed at a side of the input opening 154a of the gear housing 154 and the first O-ring 161 is mounted thereon, the present disclosure is not limited to a corresponding position, and it should be understood that the O-ring accommodation groove may be formed to be recessed at a side of the motor cover 122 and the first O-ring 161 may be seated thereon, or the first O-ring 161 may be provided at each side of the motor 120 and the gear housing 154.

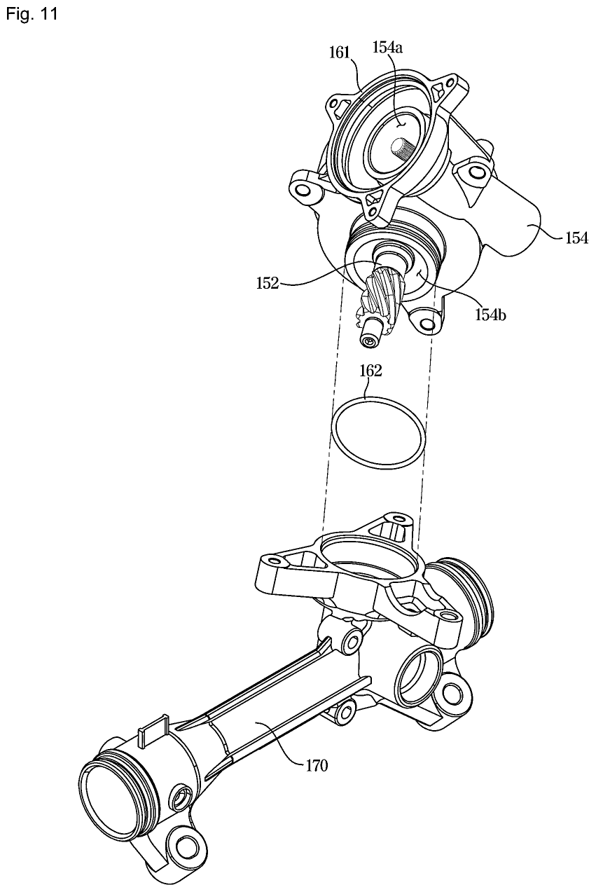

FIG. 11 is an exploded perspective view of the gear housing 154, the second O-ring 162, and the rack bar housing 170 according to an embodiment of the present disclosure. Referring to FIG. 11, the second O-ring 162 is provided between a side of the output opening 154b of the gear housing 154 and the rack bar housing 170, thereby preventing moisture from entering the inner space of the gear housing 154 from the outside of the gear housing 154. For example, like the first O-ring 161, the second O-ring 162 may be provided in a ring shape, may be made of an elastically deformable material, and may be seated on an O-ring accommodation groove formed to be recessed in a radial direction on an outer circumferential surface of a circumferential side of the output opening 154b, thereby preemptively preventing external moisture from flowing into the inner space of the gear housing 154. However, although FIG. 11 shows that the O-ring accommodation groove is formed at a side of the output opening 154b of the gear housing 154 and the second 162 is mounted thereon, the present disclosure is not limited to a corresponding position, and it should be understood that the O-ring accommodation groove may be formed to be recessed at a side of the rack bar housing 170 and the second O-ring 162 may be seated thereon, or the second O-ring 162 may be provided at each side of the gear housing 154 and the rack bar housing 170.

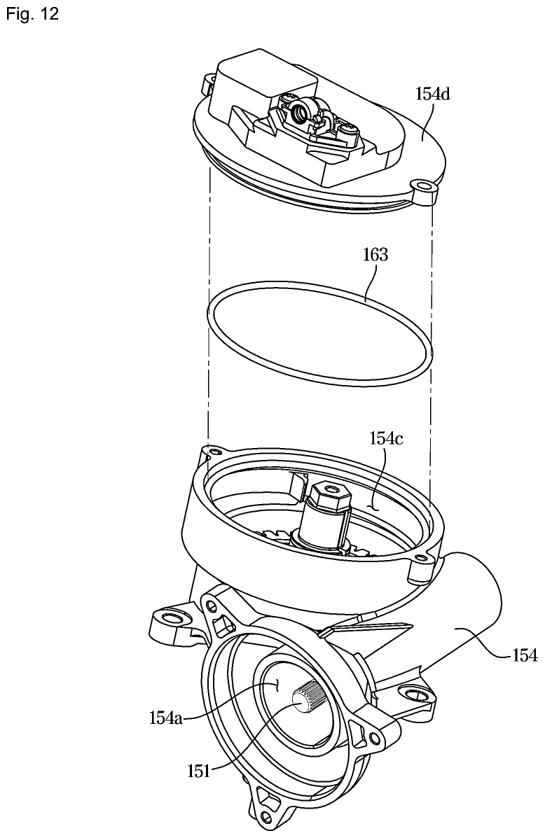

FIG. 12 is an exploded perspective view of the gear housing 154, the third O-ring 163, and the sensor cover 154d according to an embodiment of the present disclosure. Referring to FIG. 12, the third O-ring 163 is provided between a side of the detection opening 154c of the gear housing 154 and the sensor cover 154d, thereby preventing moisture from entering the inner space of the gear housing 154 from the outside of the gear housing 154. For instance, the third O-ring 163 may be provided in a ring shape, may be made of an elastically deformable material, and may be seated on an O-ring accommodation groove formed to be recessed in a radial direction on an inner circumferential surface of the detection opening 154c of the gear housing 154, thereby preemptively preventing external moisture from flowing into the inner space of the gear housing 154. However, although FIG. 12 shows that the O-ring accommodation groove is formed at a side of the detection opening 154c of the gear housing 154 and the third O-ring 163 is mounted thereon, the present disclosure is not limited to a corresponding position, and it should be understood that the O-ring accommodation groove may be formed to be recessed at a side of the sensor cover 154d and the third O-ring 163 may be seated thereon, or the third O-ring 163 may be provided at each side of the gear housing 154 and the sensor cover 154d.

Meanwhile, as described above, a pair of bellows 180 are provided on connection portions between the rack bar 110 and the vehicle wheels to prevent moisture or foreign materials from entering the ball joints 11. Meanwhile, in the steering system 100 for the vehicle according to an embodiment of the present disclosure, the accommodation space 170s of the rack bar housing 170 and the inner space of the gear housing 154 are provided to be sealed from each other by the second oil seal 157 and the second O-ring 162, and thus the accommodation space of the rack bar housing 170 and the inner space 180s of the bellows 180 do not generate an air flow to surrounding components. In this case, when air present in the accommodation space 170s of the rack bar housing 170 and the inner space of the bellows 180 flows due to a repetitive operation of the steering system 100 and the translational motion of the rack bar 110, a portion of the bellows 180 may be subjected to a load. Accordingly, a vent hole 171 is formed in or at the rack bar housing 170 to allow the accommodation space 170s to communicate with the outside of the rack bar housing 170 and thus reduce or minimize the load applied to the bellows 180 due to the air flow as well as discharge and cool air heated when a temperature of the accommodation space 170s rises due to long-term operation of the steering system 100.

FIG. 13 is a cross-sectional view cut along line A-A′ of FIG. 2. Referring to FIG. 13, the vent hole 171 may be formed to pass through one side of the rack bar housing 170. The vent hole 171 allows an air flow between the accommodation space 170s of the rack bar housing 170 and the outside of the rack bar housing 170 thereby preventing air flow from being concentrated on one portion in the accommodation space 170s of the rack bar housing 170 and the inner space 180s of the bellows 180 communicating therewith. A cap member 172 may be installed in the vent hole 171 to allow an air flow between the outside of the rack bar housing 170 and the accommodation space 170s and prevent the inflow of foreign materials. The cap member 172 is inserted into the vent hole 171 to suppress the inflow of foreign materials through the vent hole 171. A groove or a protrusion may be provided on the cap member 172 to form a gap with the vent hole 171, thereby generating an air flow between the outside and the accommodation space.

Alternatively, a filter member may be mounted in the vent hole 171 to allow an air flow between the outside of the rack bar housing 170 and the accommodation space 170s and prevent moisture and foreign materials from passing therethrough. The filter member may be installed in the vent hole 171 to prevent external moisture and foreign materials from flowing through the vent hole 171 and allow an air flow between the outside of the rack bar housing 170 and the accommodation space 170s of the rack bar housing 170, thereby suppressing a phenomenon in which the load is applied to the bellows 180 and improving durability of the bellows 180.

Meanwhile, although FIG. 13 shows that one vent hole 171 is formed in or at a portion of the rack bar housing 170 facing forward from the vehicle, and one cap member 172 is also provided and mounted in the vent hole 171, this is merely an example for helping understanding of the present disclosure, and of course, the number and positions of vent holes 171 may be variously changed according to operating conditions of the vehicle or an environment of a sales market.

Hereinafter, a steering system 100 for a vehicle according to a modified embodiment of the present disclosure will be described.

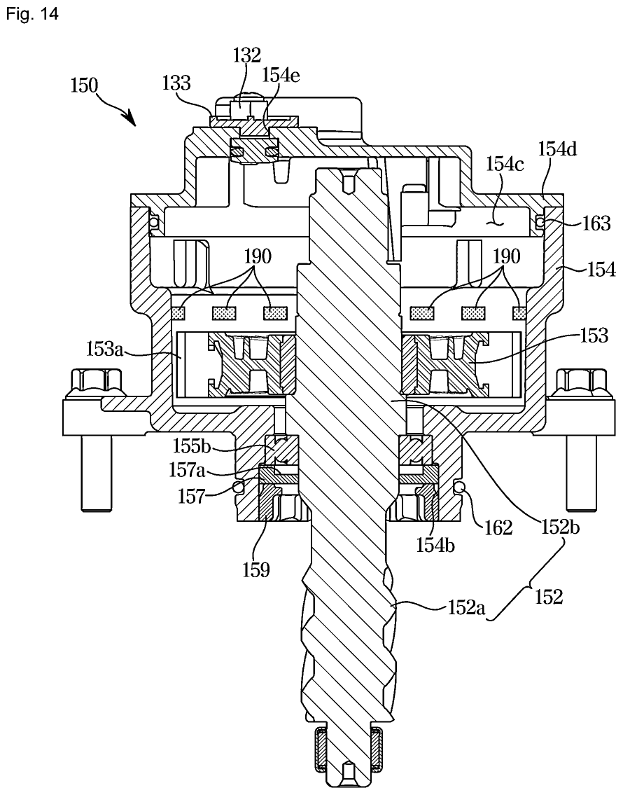

FIG. 14 is a cross-sectional view for illustrating main parts of the steering system 100 for a vehicle according to a modified embodiment of the present disclosure. Referring to FIG. 14, a gear housing 154 may further include moisture absorbents 190 configured to absorb moisture flowing into or entering an inner space.

The plurality of moisture absorbents 190 may be provided on an inner surface or in an inside space of the gear housing 154. As described above, an inner space of the gear housing 154 is sealed by the first and second oil seals 156 and 157 and the first to third O-rings 161, 162, and 163 to prevent the inflow of moisture into the gear housing 154. However, during a manufacturing process of the gear assembly 150, the gear assembly 150 may be assembled in a state in which moisture flows into the inner space of the gear housing 154, and when the oil seal 156, 157 or the O-ring 161, 162, 163 is partially deformed due to long-term operation or misalignment of the steering system 100, the moisture may flow into or be present in the inner space of the gear housing 154. Thus, the moisture absorbent 190 is provided on the inner surface or the inside space of the gear housing 154 to remove water or moisture flowing into or present in the inner space of the gear housing 154, thereby minimizing or reducing the deformation of a worm wheel 153. Since worm gear teeth 153a may be made of polyamide, the worm gear teeth 153 are likely to be deformed by moisture. Thus, the moisture absorbent 190 may be disposed adjacent to the worm wheel 153 on the inner surface of the gear housing 154. The moisture absorbent 190 may be made of various materials such as silica gel or activated alumina capable of adsorbing moisture present in the inner space of the gear housing 154.

In the steering system 100 for the vehicle according to an embodiment of the present disclosure, the oil seals 156 and 157 may be mounted on the outer circumference of the input shaft 151 and the output shaft 152 of the gear assembly 150 to block moisture from flowing into the inner space of the gear housing 154 from the motor housing 121 and the rack bar housing 170 which are surrounding or covering components of the gear assembly 150, thereby preventing the deformation of one or more elements of the gear assembly 150. In addition, the O-rings 161, 162, and 163 are installed between the opening of the gear housing 154 and adjacent components to preemptively prevent moisture from flowing into the inner space of the gear housing 154 from the outside of the steering system 100, thereby more stably suppressing the deformation of one or more elements of the gear assembly 150. In the steering system 100 for the vehicle according to an embodiment of the present disclosure, the deformation of one or more elements of the gear assembly 150 can be effectively prevented without a separate clearance compensator for preventing a clearance caused by the deformation of one or more element of the gear assembly 150, thereby reducing manufacturing costs of a device and improving assemblability and productivity of the device.

In addition, even when the inner space of the gear housing 154 is sealed from the inner space (accommodating space) of the rack bar housing 170, the vent hole 171 is formed in or on the rack bar housing 170 to facilitate an air flow in the accommodating space of the rack bar housing 170, despite a repetitive translational motion of the rack bar 110, thereby preventing the deformation of various components and improving durability thereof.

According to a steering system for a vehicle according to some embodiments of the present disclosure, it is possible to prevent the deformation of various components and improve the durability of a device.

According to a steering system for a vehicle according to certain embodiments of the present disclosure, it is possible to prevent a clearance between gear elements to improve operational reliability of the steering system.

According to a steering system for a vehicle according to some embodiments of the present disclosure, it is possible to reduce operating noise and vibration from the steering system.

According to a steering system for a vehicle according to certain embodiments of the present disclosure, it is possible to improve the efficiency of manufacturing and installation processes with a simple structure.

According to a steering system for a vehicle according to some embodiments of the present disclosure, it is possible to suppress increase in manufacturing cost to improve product competitiveness.

According to a steering system for a vehicle according to certain embodiments of the present disclosure, it is possible to stably steer wheels under various operating conditions of a vehicle and give a comfortable operational feeling to a driver.

What is claimed is:

1. A steering system for a vehicle, the steering system comprising:
a rack bar having end portions connectable to vehicle wheels, respectively;
a motor configured to provide force; and
a gear assembly connected between the rack bar and the motor to transmit the force provided by the motor to the rack bar,
wherein the gear assembly includes:
an input shaft operably connected to the motor to receive the force from the motor;
an output shaft operably connected to the rack bar to transmit the force received through the input shaft to the rack bar; and
a seal member provided on an outer circumferential surface of at least one of the input shaft and the output shaft of the gear assembly connected between the rack bar and the motor.

2. The steering system of claim 1, wherein:
the gear assembly further includes a reduction gear provided between the input shaft and the output shaft; and
the seal member includes one or more oil seals having a ring shape.

3. The steering system of claim 2, wherein:
the gear assembly further includes a gear housing accommodating the input shaft, the reduction gear, and the output shaft; and
the oil seals include a first oil seal provided between the input shaft of the gear assembly and the gear housing and a second oil seal provided between the output shaft of the gear assembly and the gear housing.

4. The steering system of claim 3, wherein:
the gear housing includes an input opening such that at least a portion of the input shaft of the gear assembly passes through the input opening of the gear housing and is exposed to the motor, and an output opening such that at least a portion of the output shaft of the gear assembly passes through the output opening of the gear housing and is exposed to the rack bar;
the first oil seal is interposed between the input shaft of the gear assembly and an inner circumferential surface of the input opening of the gear housing; and
the second oil seal is interposed between the output shaft of the gear assembly and an inner circumferential surface of the output opening of the gear housing.

5. The steering system of claim 4, wherein:
the input shaft includes:
a first screw portion on an outer circumferential surface of the input shaft, wherein first gear teeth of the first screw portion of the input shaft are engaged with the reduction gear, and
a first body extending from the first screw portion of the input shaft toward the motor; and
the first oil seal is interposed between an outer circumferential surface of the first body of the input shaft of the gear assembly and the inner circumferential surface of the input opening of the gear housing.

6. The steering system of claim 4, wherein:
the output shaft includes:
a second screw portion on an outer circumferential surface of the output shaft, wherein second gear teeth of the second screw portion are engaged with the rack bar, and
a second body extending from the second screw portion of the output shaft toward the reduction gear; and
the second oil seal is interposed between an outer circumferential surface of the second body of the output shaft of the gear assembly and the inner circumferential surface of the output opening of the gear housing.

7. The steering system of claim 5, wherein the gear assembly further includes:
a first bearing provided between the first body of the input shaft of the gear assembly and the inner circumferential surface of the input opening of the gear housing; and
a damper provided between the first oil seal and the first bearing.

8. The steering system of claim 6, wherein the gear assembly further includes a second bearing provided between the second body of the output shaft of the gear assembly and the inner circumferential surface of the output opening of the gear housing.

9. The steering system of claim 8, wherein a recessed groove is formed on a surface of the second oil seal facing the second bearing so that the second oil seal does not contact an inner ring of the second bearing.

10. The steering system of claim 5, wherein the gear assembly further includes a first sealing plug mounted in the input opening of the gear housing or on the first body of the input shaft of the gear assembly such that the first sealing plug supports the first oil seal.

11. The steering system of claim 6, wherein the gear assembly further includes a second sealing plug mounted in the output opening of the gear housing to support the second oil seal.

12. The steering system of claim 3, further comprising:
a motor housing accommodating the motor; and
a first O-ring provided between the gear housing and the motor housing.

13. The steering system of claim 3, wherein:
the input shaft comprises a worm shaft; and
the reduction gear comprises a worm wheel rotatably engaged with the worm shaft of the input shaft and rotatably engaged with the output shaft.

14. The steering system of claim 13, wherein:
the worm wheel of the reduction gear includes worm gear teeth provided on an outer circumferential surface of the worm wheel; and
the worm gear teeth have a polyamide material.

15. The steering system of claim 3, further comprising:
a rack bar housing including a hollow to have an inner accommodation space for accommodating the rack bar; and
stretchable bellows mounted at each of end portions of the rack bar housing,
wherein the rack bar housing includes a vent hole passing through the rack bar housing and configured to allow an air flow between an outside of the rack bar housing and the inner accommodation space of the rack bar housing.

16. The steering system of claim 15, wherein the rack bar housing further includes a cap member mounted in the vent hole and configured to allow the air flow and block inflow of foreign materials from the outside of the rack bar housing to the inner accommodation space of the rack bar housing.

17. The steering system of claim 15, wherein the rack bar housing further includes a filter member mounted in the vent hole and configured to allow the air flow and prevent foreign materials or moisture from passing through the filter member.

18. The steering system of claim 15, further comprising a second O-ring provided between the gear housing and the rack bar housing.

19. The steering system of claim 3, further comprising:
an electronic control unit configured to control the motor;
an angle sensor configured to detect rotation of the output shaft of the gear assembly; and
a sensor connector electrically connecting the angle sensor to the electronic control unit,
wherein:
the gear housing further includes a detection opening formed at a side of the gear housing opposite to another side of the gear housing in which the output opening of the gear housing is formed, and a sensor cover covering the detection sensor; and
the angle sensor and the sensor connector are mounted to the sensor cover.

20. The steering system of claim 19, further comprising a third O-ring provided between the gear housing and the sensor cover.
